(19) United States
(12) Patent Application Publication
(10) Pub. No.: US 2002/0055339 A1
(43) Pub. Date: May 9, 2002

(54) Apparatus and method for identifying a performance

(76) Inventors: Ariel S. Rogson, Portland, OR (US); Gregory T. Kavounas, Vancouver, WA (US)

Correspondence Address: MARGER JOHNSON & MCCOLLOM PC, 1030 SW MORRISON STREET, PORTLAND, OR, 97205, US

(21) Appl. No.: 09/902,826

(22) Filed: Jul. 10, 2001

Related U.S. Application Data
(60) Provisional application No. 60/232,966, filed on Sep. 14, 2000.

(51) Int. Cl. H04B 1/18

(52) U.S. Cl. 455/186.1; 455/185.1

(57) ABSTRACT

A radio includes storage. When a performance is performed, the title is included in the signal, data stream, or a sideband. The radio receives, decodes, and stores the title of the performance in the storage. When the user requests the radio to present the title of the performance, the radio informs the user of the title of the performance.

### FIELD OF THE INVENTION

This invention pertains to presenting titles for works during performance.

### BACKGROUND OF THE INVENTION

The industry of performance works has changed substantially in the last 150 years. Before Thomas Edison invented the phonograph, the only way people could hear a musical work was by attending the performance in person. Since then, many inventions have allowed people to enjoy performance works without having to attend the performance in person. Aside from records (and their modern reincarnations, audiocassettes, compact discs (CDs), and minidiscs), videocassettes and digital versatile discs (DVDs) allow people to enjoy visual works. As time passes, we may yet witness new media used to store presentations.

In general, audiocassettes, CDs, minidiscs, videocassettes, and DVDs or their containers include some physical listing that visibly presents the user with the title of the work. In the case of CDs and DVDs, individual tracks, which can be located through random access of the disc, can also be labeled. But accessing the title listing is not always convenient. For example, since audiocassettes, CDs, minidiscs, videocassettes, and DVDs are generally built to withstand rough treatment, people tend to discard or misplace the box in which the work came. Without the box, it is difficult to identify the title of the work. Further, given the small print used on the box, attempting to locate the title of an individual track on an audiocassette, a CD, or a minidisc is distracting and sometimes even hazardous. For example, when a driver of a vehicle is attempting to read the title of a track, he is not paying attention to his driving.

Of all the media used to store performances, only DVDs consistently provide performance information recorded directly on the disc. And even then, the performance information is not accessible while the performance is underway.

The advent of radio for aural works has presented a different problem. Although disk jockeys sometimes announce the work before the performance (and this is by no means always true), people often tune in part way through the performance of the work. They therefore miss the announcement of the work.

Technology has made some attempts to address the problem, but only by adapting new technology to the problem, not by changing existing technology to solve the problem. For example, people can now receive radio broadcasts over their computers. Netradio <http://www.netradio.com> is a company that provides broadcasts over the Internet that include the title of the pieces being performed. Other Internet broadcasts provide similar capabilities. But with Internet broadcasts, the computer establishes the connection request to the broadcast source. As part of the connection request, the computer simply requests the title of the work. This is an active request for the title of the work on the part of the computer. In contrast, radio is a one-way transmission mechanism: the receiver is a passive participant. There is no way to modify the radio to request the title of a work without turning the radio into a two-way transmitter/receiver.

In the realm of music, computers now scan CDs to identify the CD using a unique identifier. This information is then sent over the Internet to a web site, which then returns track information to the computer. Internet-enabled portable CD players can also access this information. But currently, portable Internet access is expensive and slow, and would be wasteful on simple uses such as performance title information. Further, there is no technology to adapt this solution to any form of audiocassette player, as audiocassettes do not store unique identifiers on the media.

Finally, in the realm of television, cable and satellite television providers usually set aside one channel to store information about the shows being broadcast on the other channels. But this solution is of no value to people who rely on only broadcast television, and even cable and satellite television viewers must switch away from the broadcast to access this information. (The increasing availability of picture-in-picture televisions is mitigating the problem of having to switch channels to access such information.) And videocassettes, like audiocassettes, do not provide any information about the performance stored thereon during playback.

Pre-recorded movies on videocassette do provide title information about the recorded work. But, again, the title information is only available at the specific point in the movie where the title is recorded, almost always at the beginning of the movie. No mechanism is provided for accessing the title information at any other point in the movie. And where a videocassette recorder starts recording a program at the wrong time, the user is again left without any title information about the recorded broadcast.

Accordingly, a need remains for an apparatus and method that allows a user to determine the title of a work during performance without having to locate the enclosing box.

### SUMMARY OF THE INVENTION

The invention is a method and apparatus for presenting the title of a work to a user through a playback device. In a first embodiment of the invention, a radio is designed to receive title information at the same time as the performance is received. The transmitting source transmits the title information simultaneously with the performance information, preferably interleaved with the performance or on a sideband of the performance. The radio receives the title of the work as a component of a signal or data stream containing the work being played. The radio then extracts and stores the title. During performance of the work, either continuously or if the user requests the title of the work, the radio presents the title of the work to the user.

In a second embodiment of the invention, a standalone playback device is designed to access title information about the performance from the medium on which the performance is stored. The title information is buffered within the playback device. During performance of the work, if the user requests the title of the work, the playback device presents the title of the work to the user.

The foregoing and other features, objects, and advantages of the invention will become more readily apparent from the following detailed description, which proceeds with reference to the accompanying drawings.

### BRIEF DESCRIPTION OF THE DRAWINGS

FIG. 1 shows a car receiving the title of a work via radio from a transmitter according to a first embodiment of the invention.

FIG. 2 shows the panel of the radio within the car of FIG. 1, adapted to receive, store, and display the title of the work according to the first embodiment of the invention.

FIG. 3 shows a holographic display used to present the title of a work in the car of FIG. 1.

FIG. 4A shows a graph of the human ear's sensitivity to sound frequencies, and one of possible positions of a sub-band in which to transmit a title of the invention.

FIG. 4B shows a circuit for displaying the title of a song transmitted as per FIG. 4A according to an embodiment of the invention.

FIG. 4C shows a circuit for announcing the title of a song transmitted as per FIG. 4A according to an embodiment of the invention.

FIG. 5 shows a graph of frequencies used in radio transmission, for which a sideband transmission can be chosen on which to broadcast the title of a work according to the first embodiment of the invention.

FIGS. 6A-6B show a flowchart of the method for storing and presenting to the user the title of a work being performed on the radio of FIG. 1 according to the first embodiment of the invention.

FIG. 7 shows a flowchart of the method for loading and broadcasting the title of a work on the transmitter of FIG. 1 according to an embodiment of the invention.

FIG. 8 shows a portable playback device designed to access the title of a work from the medium according to a second embodiment of the invention.

FIG. 9 shows a flowchart of the method for buffering and presenting to the user the title of a work being performed on the portable playback device of FIG. 8 according to the second embodiment of the invention.

FIG. 10 shows a medium on which the title of a work can be stored according to a third embodiment of the invention.

FIG. 11 shows a flowchart of the method for recording a work and the title of a work on the medium of FIG. 10 according to the third embodiment of the invention.

### DETAILED DESCRIPTION OF THE PREFERRED EMBODIMENT

### Radio Receiver

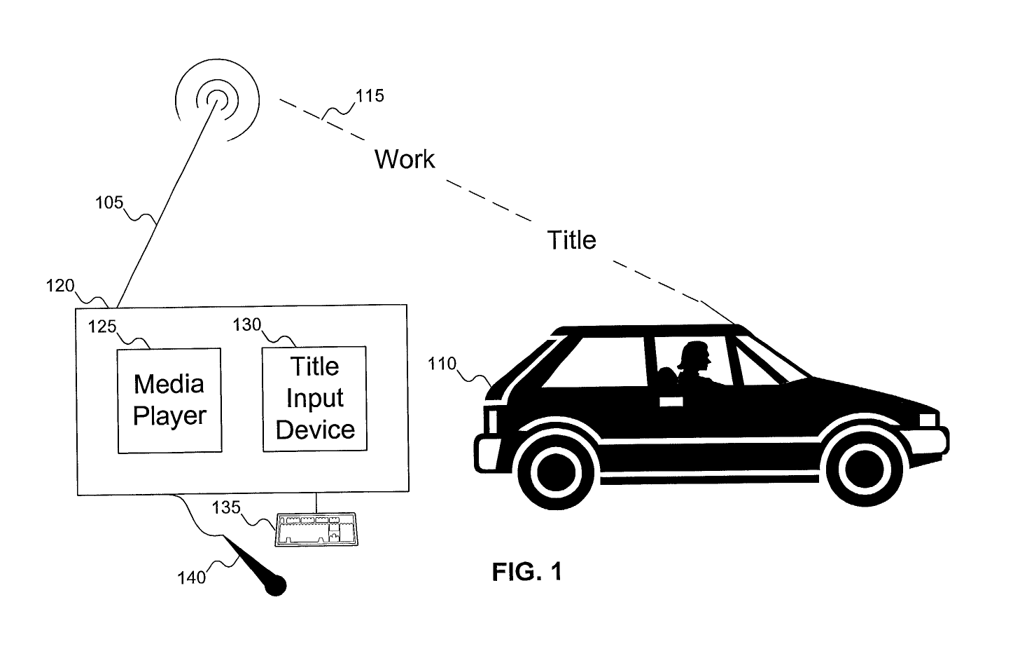

FIG. 1 shows a car receiving the title of a work via radio and presenting the title of the work to the user according to a first embodiment of the invention. In FIG. 1, broadcast antenna 105 is transmitting music to a radio receiver in car 110. Transmission sequence 115 shows the music being transmitted to car 110. As can be seen in transmission sequence 115, antenna 105 transmits a signal containing both the title of the work and the work itself.

A person skilled in the art will recognize that other types of information other than music can be transmitted from antenna 105, and that forms of communication other than electromagnetic transmission or radio can be used. The remainder of this document will describe transmission of the work using radio. Similarly, although the first embodiment of the invention is presented in terms of a radio in a car, a person skilled in the art will recognize that the first embodiment of the invention is extensible to other types of radio receivers: for example, portable radios or home stereo receivers.

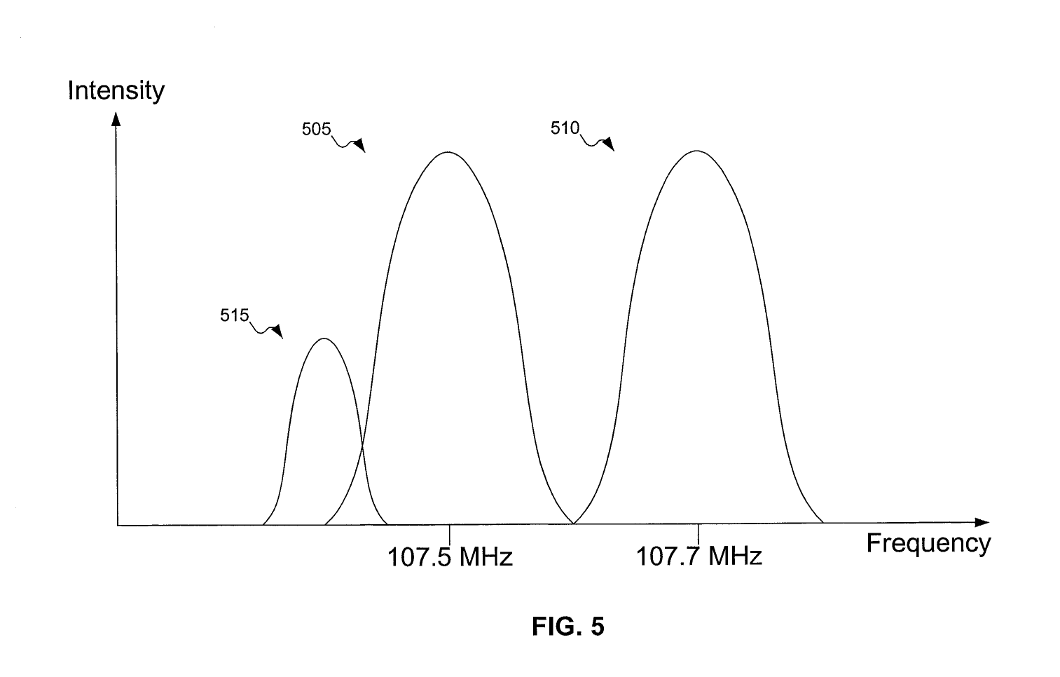

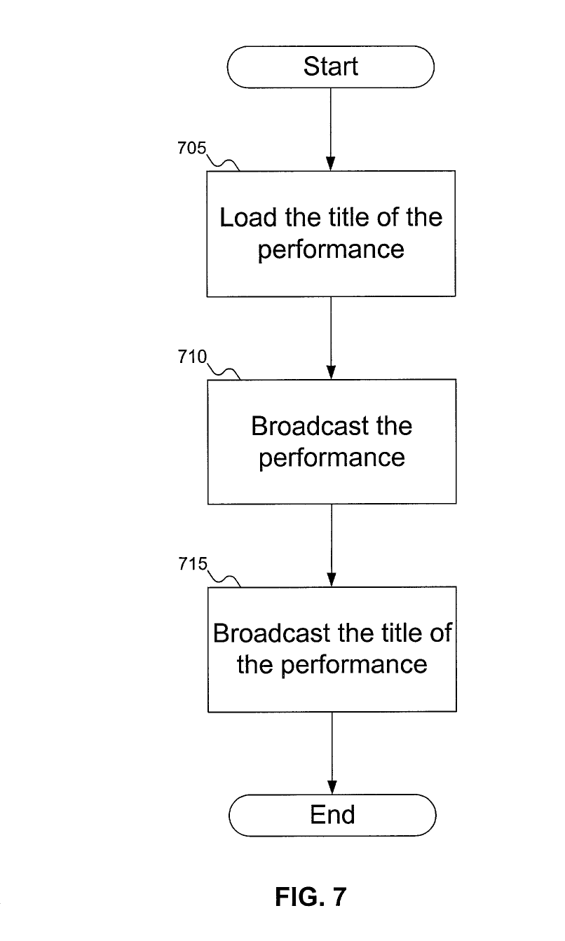

The title of the work is generally relatively short, even including the composer or performer of the work. Transmitting the title of the work requires a short amount of time relative to the length of the work. If data compression is used, it is possible to further reduce the time required to transmit the title of the work. But even without compression, transmitting the title of the work generally requires less than one second, an acceptable amount of dead time. In one variation of the first embodiment, the title of the work is transmitted only at the beginning of performance. The radio in car 110 then decodes and buffers the title of the work. Alternatively, if one second of dead time is too much, the title can be interleaved into the beginning of the broadcast of the performance itself, with only a possible slight loss of performance quality. As a further alternative, the title data can be transmitted and received via a sideband of the frequency band carrying the performance. Sideband transmission will be discussed with reference to FIGS. 5 and 7 below.

Although transmitting the title of the work at the beginning of the performance will suffice for users listening from the beginning of the performance, for users who tune in during the middle of the performance, a single transmission of the title of the work at the start of the performance will not be sufficient. To allow for this possibility, antenna 105 can retransmit the title of the work sporadically during the performance of the work, for example, every minute. Again, as noted above, the title will not require lengthy transmission and can be interleaved with the performance of the work, or can be retransmitted intermittently during performance via frequency modulation (FM) sideband. However the title of the work is transmitted, the radio in car 110 stores the title of the work for recall or display.

Although preferably in FIG. 1 the medium from which the recording is being transmitted is encoded with the title of the work, this may not be the case. For example, existing media generally do not have title information encoded thereon, nor do conventional receivers or playback machines have any means for extracting and displaying such information. Further, when a performance is being broadcast live, there is no medium from which to read the title information. For these situations, the transmitter includes equipment for input of the title of the work. In FIG. 1, transmitter 120 includes media player 125 and title input device 130. Media player 125 can be a CD player, an audiocassette player, a DVD player, or any other form of media reading device. For purposes of live broadcast, media player 125 can be microphones and other equipment used to capture the performance for transmission. A person skilled in the art will recognize other forms media player 125 can take.

Title input device 130 allows the person controlling the transmission to input the title of the work being broadcast. For example, in FIG. 1, the person controlling the broadcast can use keyboard 135 to type a title that can be displayed graphically to the person receiving the broadcast. Alternatively, the person controlling the broadcast can use microphone 140 to orally present a title for the work. This oral presentation of the title can be interleaved with the broadcast of the work and stored for later recall by the radio in car 110. Then, if the user desires to hear the title information, the radio in car 110 can play back by the spoken title. A person skilled in the art will recognize other forms title input device 130 can take.

In another variation of the first embodiment, the title information can be a universal resource locator (URL) on which information about the work is available. With the increasing availability of Internet-enabled devices, including automobiles, an Internet-enabled device can access title information from an Internet and provide the information to the user.

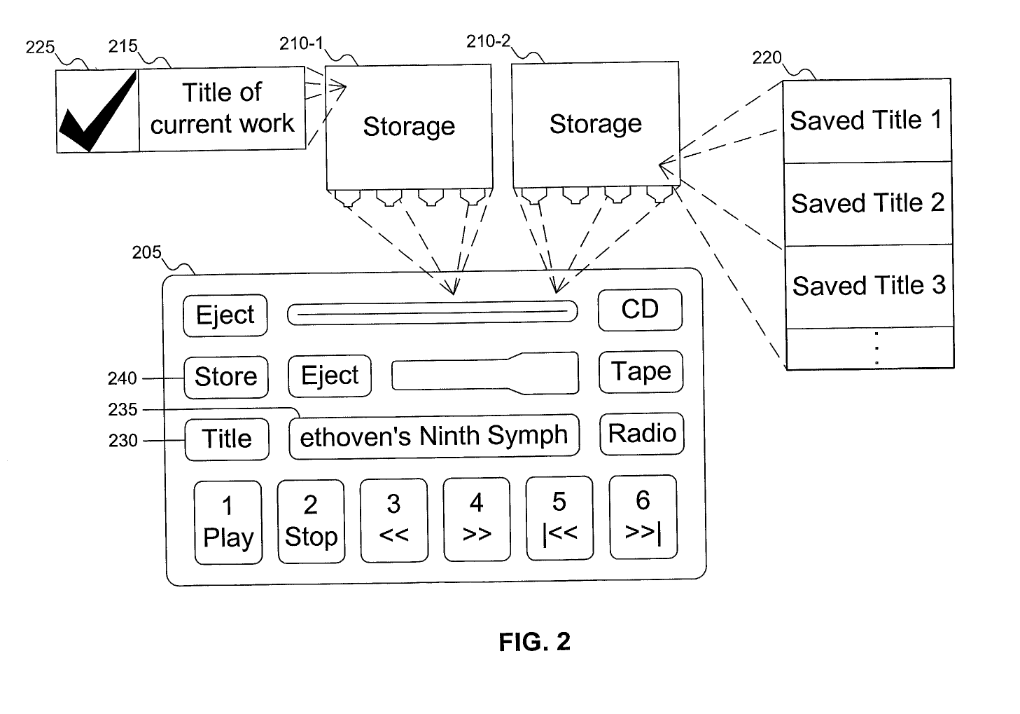

FIG. 2 also shows dashboard 205 of car 110 from FIG. 1. Dashboard 205 includes all the standard controls for selecting and controlling playback of a compact disc, audiocassette, or radio performance. As part of the equipment behind dashboard 205, dashboard 205 includes two storages 210-1 and 210-2. Storage 210-1 is designed to store the title of the work currently being performed on the radio of car 10 from FIG. 1. For example, title 215 is stored within storage 210-1 and is the title of the work currently being performed.

Once received from the transmission source (in FIG. 1, via antenna 105), the radio demodulates, decodes, and stores the title of the work in storage 210-1. Because the title of the work is generally very short, 256 bytes of storage should be adequate for all but the longest work titles. But additional memory can also be provided to enable receipt, storage, and readout of additional information. For example, information such as the record company, a unique identifier for the recording of the work, the performer of the work, and other such information can be transmitted in addition to the title of the work.

It can occur that the user wants to know the title of a work previously performed. Storage 210-2 stores the title of past works performed. For example, within storage 210-2 is list 220 of past works performed on the radio. If the user wants to add the title of the current work to list 220, title 215 is marked for transfer to storage 210-2 when the current performance ends. This is indicated graphically by check mark 225 in FIG. 2 (although a person skilled in the art will recognize that in computer memory, only a single bit would be needed to tag an entry for continued storage, rather than a graphical display). In one variation of the first embodiment of the invention, the title of the current work is transferred to storage 210-2 only when the user requests it. In a second variation of the first embodiment of the invention, the title is automatically transferred to storage 210-2 without the user needing to request transfer.

Although storages 210-1 and 210-2 are shown as distinct elements in FIG. 2, a person skilled in the art will recognize that they can be combined into a single element. Thus, a single storage can store both the title of the current work being performed and the titles of past works performed.

Now that the “behind-the-scenes” elements of dashboard 205 have been explained, the modified control panel can be presented. Dashboard 205 includes title button 230. When the user wants to know the title of the work, the user presses title button 230. The title is then presented in display 235. In a variation of the first embodiment of the invention, display 235 includes a light emitting diode (LED) display. The LED display is preferred, because it allows simpler implementation of a scrolling display and enables presentation of more character shapes. But use of a liquid crystal display (LCD) is also possible. Note that in FIG. 2, display 235 is not large enough to display the entire title, so the title scrolls across display 235.

In another variation of the first embodiment of the invention, the title of the work is presented orally. This can be done using a synthesized voice to recite the title of the work, or by playing a recorded title. In this variation, the stereo system of the car temporarily replaces the normal output of the radio with the oral presentation of the title of the work. Once the title of the work has been presented, the stereo system of the car returns to normal output of the work.

In yet another variation of the first embodiment, dashboard 205 includes a microphone (not shown in FIG. 2). The microphone picks up spoken commands, which are transmitted to a microprocessor, which is programmed to recognize speech. Then, the user can speak into the microphone and aurally request the title for voice-activated command and control. In this case, title button 230 is not needed.

Display 235 can be shared with other functions of dashboard 205. For example, dashboard 205 typically includes a display to show the radio station to which the radio is tuned. Dashboard 205 also typically identifies for the user which track of an inserted compact disc (CD) is being played. Display 235 can be shared with the display used for these presentations. Alternatively, display 205 can be a heads-up display: for example, projecting the title onto a portion of the windshield. And when holographic projection becomes economical in consumer applications, e.g., automobiles, holographic display of the title can be done. Holographic projection especially can be easier than a heads-up display for portable playback devices. Holographic projection will also allow for the possibility of graphical display of non-textual information transmitted with the title: for example, an image of the cover of the jewel box. Some automobiles also have an in-dash text display that can be used to display the title information.

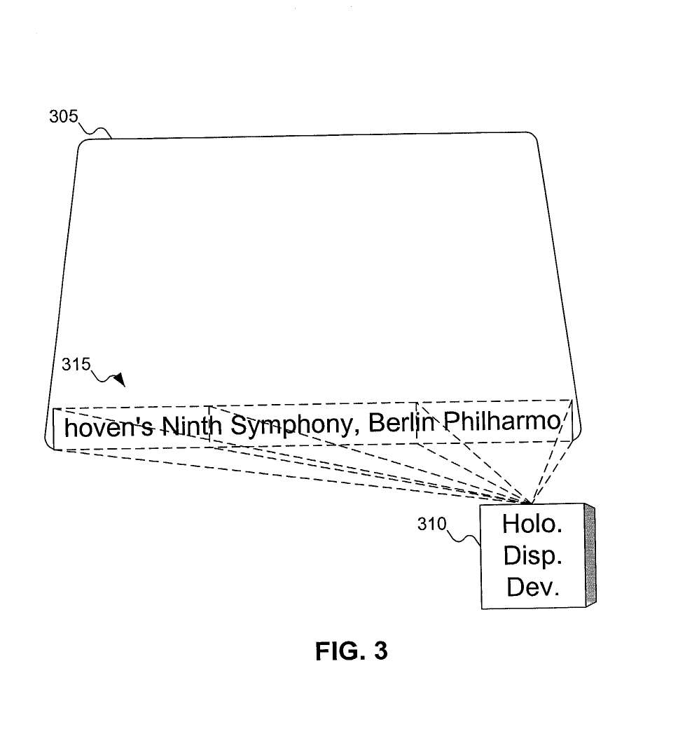

FIG. 3 shows windshield 305 of car 110 of FIG. 1. In FIG. 3, holographic display device 310 is projecting projection 315 onto windshield 305. The title information of the current work is accessed from storage 210 (not shown in FIG. 3) and projected onto projection 315. A person skilled in the art will recognize how this can be adapted for use in a heads-up display, as well as other ways to present the title of the work.

Returning to FIG. 2, it can happen that the title of the work is divided into multiple components. For example, with classical music the user might want to know the name of the piece being performed, the name of the performer, and the composer of the work. If more than just the title of the work is transmitted and stored in this way, pressing title button 230 again presents the additional information in display 235. As discussed above, the additional information can include the performer of the work, the composer of the work, a unique identifier for the recording, the record company that produced the work, and other items.

As discussed above, in one variation of the first embodiment of the invention, the title of the work is stored in storage 210-2 only if the user requests it. For example, while the user is driving his car, he might want to store the title of the work until he reaches a safe place to pull over and write down the title. If the user wishes to retain the title information, the user can press store button 240. Once pressed, store button 240 marks the title currently in storage 210-1 for storage beyond the termination of the performance with check mark 225. (As discussed above, unless the title currently in storage 210-1 is marked for retention, once a new title is transmitted the old title is erased from storage 210-1.) Then, when a new title is received, before the old title is erased, the old title is transferred to storage 210-2.

To retrieve title stored in storage 210-2, in the first embodiment, the user presses store button 240 for a different amount of time. For example, a quick press of store button 240 can store a title: a longer press, for example three seconds in duration, indicates that the stored titles are to be displayed in order on display 235. A person skilled in the art will recognize other variations in the use of store button 240: for example, a long press to store a title and a short press to display titles, or individual presses of store button 240 to retrieve stored titles one at a time.

In dashboard 205, with all the options and buttons on dashboard 205, space can become a premium. If space is not available to add store button 240, the function of store button 240 can be grafted onto title button 230. Then, the user can store titles of work being performed by pressing title button 230 for a longer period of time, and the user can request display of stored titles with an even longer press of title button 230. But this variation is not preferred, because of the overloaded use of title button 230.

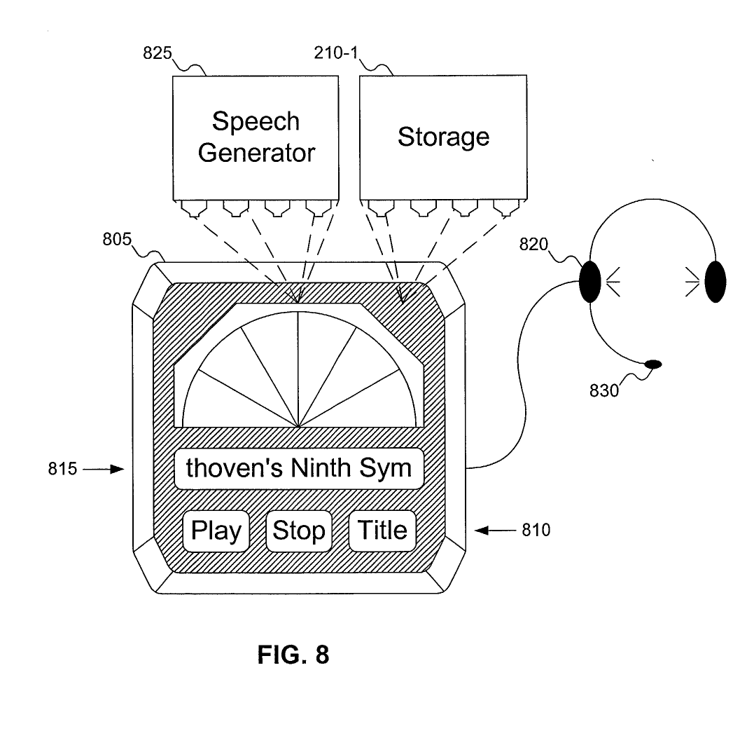

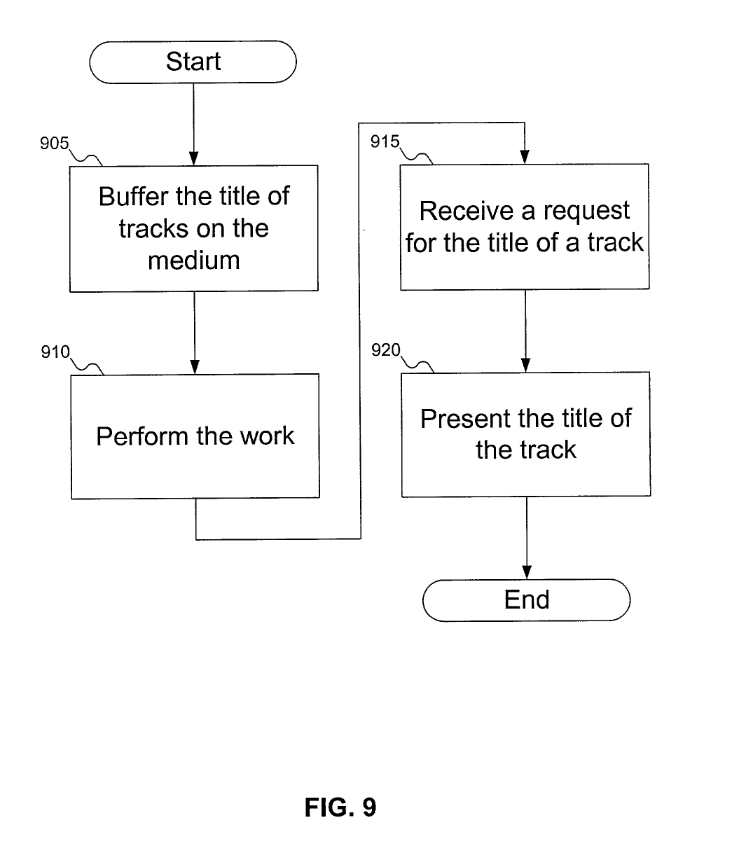

Instead of presenting the title of a work transmitted by radio, the user can be listening to a CD or audiocassette with titles stored thereon. How the invention is used when accessing a CD or audiocassette is described below with reference to FIGS. 8-9 below.

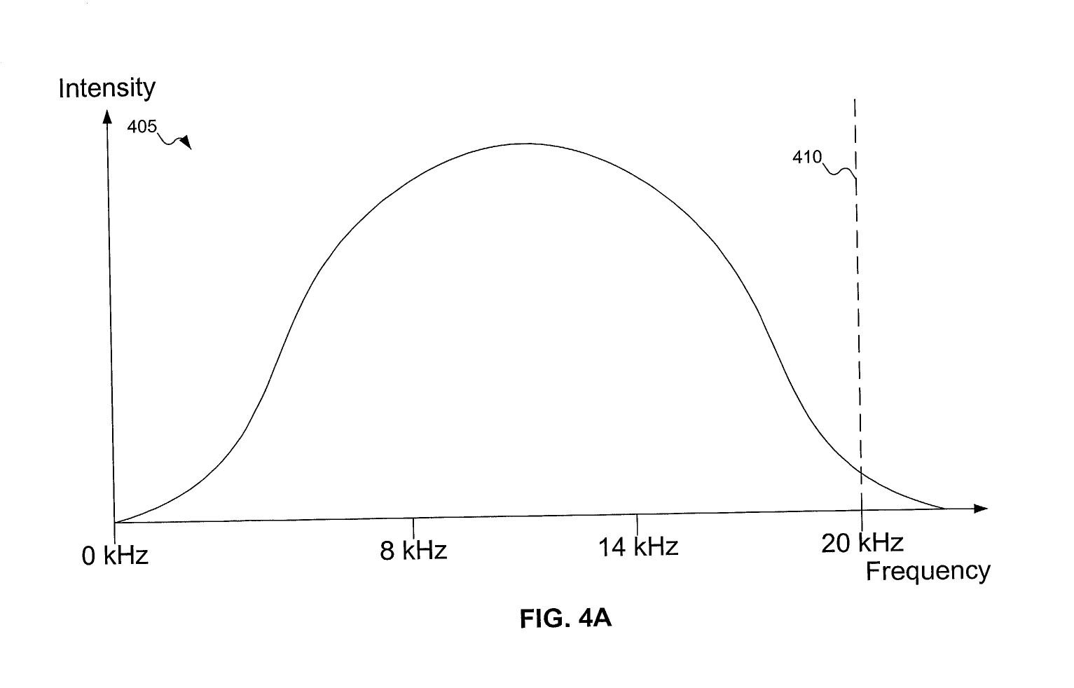

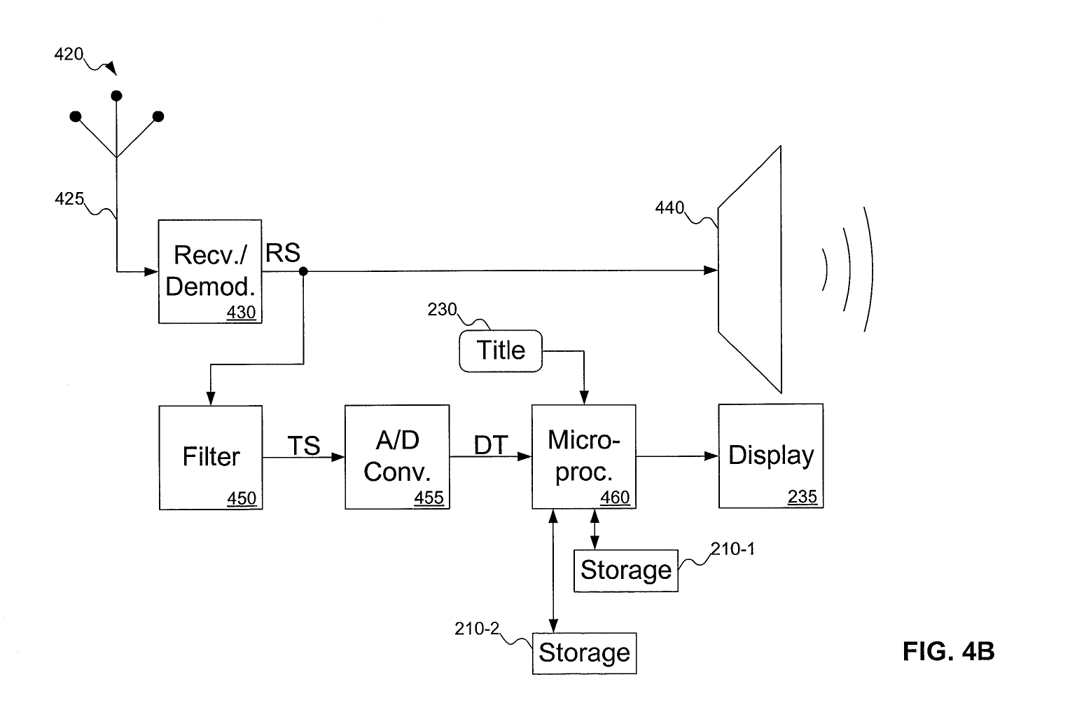

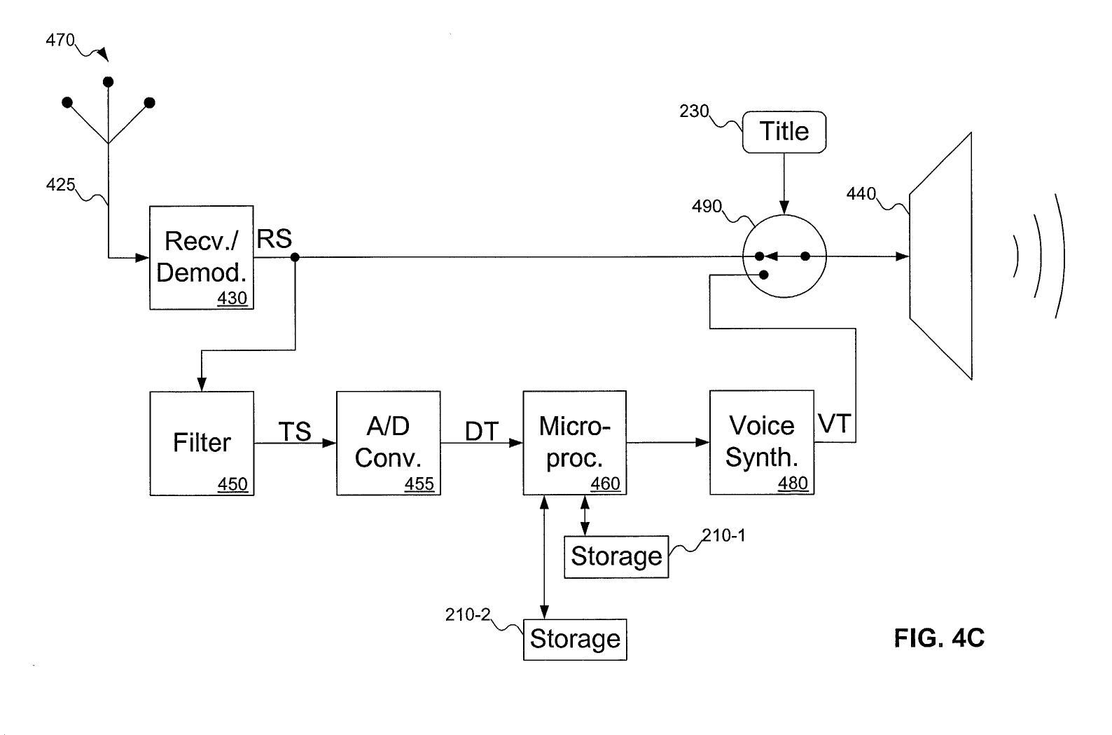

FIG. 4A shows graph 405 of frequencies that can be heard by the human ear, within which a sub-band can be chosen on which to broadcast the title of a work according to the first embodiment of the invention. In FIG. 4A, graph 405 is roughly bell-shaped. The human ear can generally hear frequencies up to around 20 kHz, with the best hearing in the range from 8 kHz to 14 kHz. At the extremes of human hearing, the human ear's ability to discern distinct sounds weakens. Very low sounds are more commonly felt as rumbling frequencies, and at the upper end of the spectrum, the frequencies generally become too high to hear (although they are audible to other animals, such as cats and dogs).

Frequency 410 represents a sub-band of the audible spectrum of graph 405. Frequency 410 is selected as a frequency that is generally beyond the usual range of the human ear. In FIG. 4A, frequency 410 is around 20 kHz, but a person skilled in the art will recognize that this frequency selection is only an example and not a limitation, and that a different frequency can be selected. Because this frequency is outside the range of human hearing, any sound information encoded at this frequency can be removed from the transmission of a performance without a noticeable effect to the listener. Then, this frequency can be used to transmit the title information. Use of a sub-band according to the first embodiment of the invention will thus not interfere with listening to the sound performance. The identification message is thus received and decoded. Title information generally is transmitted as binary information for storage within a micro-processor within the radio. Techniques for encoding binary information within a specific frequency are generally known in the art and will not be described here. Redundant transmission can also be used to reduce the odds of non-receipt.

A person skilled in the art will immediately realize that this description pertains to both transmitting and receiving, since they would have to be compatible. In both cases, radio waves are broadcast and received. Performance radio waves, which encode performance data that represent a sound performance, are transmitted and received simultaneously with identification radio waves, which encode identification data that represent an identification message about the sound performance. Preferably they are of the same radio wavelength and frequency. The broadcast performance radio waves are decoded to play out a sound performance through a speaker of the radio set. The broadcast identification radio waves are decoded to play out the identification message. The identification message is played either through the speaker or through the display as discussed elsewhere in this document.

Receivers are now described for use with the transmission scheme of FIG. 4A.

Referring to FIG. 4B, an embodiment is shown for a radio receiver 420 receiving the title encoded according to FIG. 4A. Receiver 420 includes common antenna 425, receiver-demodulator unit 430, and speaker 440. The performed work is received by antenna 425, demodulated by unit 430, and sent to speaker 440 as signal RS, for being played out as sound. As is to be understood, signal RS has components distributed over the entire graph 405. It also has components (the title of the song) in sub-band 410.

Receiver 420 additionally includes filter 450. In the general case, filter 450 is a passband filter, but that need not be so. It will be apparent to a person skilled in the art that filter 450 may be made from a high pass filter, if it need not reject any frequencies higher than those of sub-band 410 in FIG. 4A. And indeed, if sub-band 410 is chosen to be at the high end of graph 405, there will be no such higher frequencies to reject. Conversely, if sub-band 410 is chosen to be at the low end of graph 405, filter 450 need only be a low pass filter.

Filter 420 receives signal RS, and outputs a resulting filtered signal TS. Signal TS includes sub-band 410, and any other of the frequency components of signal RS that were not rejected, as per the design considerations above.

Receiver 420 further includes an Analog-to-Digital Converter 455, which receives signal TS, and converts it to a digital signal DT. Preferably, signal DT encodes the title according to a preset digital protocol.

Receiver 420 moreover includes microprocessor 460, which receives signal DT and stores signal DT in memory storages 210-1 and 210-2, or a combination thereof. Memory storages 210-1 and 210-2 are discussed in more detail with reference to FIG. 2 above.

In addition, microprocessor 460 controls what is shown on display 235. Microprocessor 460 is further capable of receiving inputs from the controls of console 205, such as changing radio stations, switching from the FM band to the AM band or vice versa, and so on. For example, it can receive an interrupt from title button 230 of FIG. 2.

Equivalently, the order of filter 450 and Analog-to-Digital Converter 455 may be reversed, with applicable adjustments, for example, using a digital filter, etc.

Referring now to FIG. 4C, receiver 470 is described according to another variation of the first embodiment of the invention. Receiver 470 includes many of the components of receiver 420 of FIG. 4B. In addition, it includes voice synthesizer 480, which receives inputs from microprocessor 460. Thus it produces a voice signal VT that announces the title.

Receiver 470 also includes switch 490 that is controlled by title button 230 of FIG. 2. When button 230 is pressed, then speaker 440 receives signal VT instead of signal RS, and announces the title. Once signal VT has been received, switch 490 can select to receive signal RS again, and continue playing the performance.

In yet another variation of the first embodiment of the invention, switch 490 can receive both signal RS and signal VT simultaneously. Signal RS is played out at low volume, allowing the listener to hear the identification message sent over signal VT, which is presented at a higher volume. Then, once signal VT is completely received, switch 490 plays signal RS at normal volume.

It will be apparent to a person skilled in the art that variations of the first embodiment of the invention are possible that combine features of both receiver 420 and receiver 470.

In a further variation of the first embodiment of the invention, as discussed above, the title information can be transmitted as aural information, for presentation over the stereo system. In this case, the aural information can be modulated to a sub-band of frequencies outside the range of the human ear shown in graph 405, and transmitted on those frequencies. The radio then includes receiver circuitry tuned to the selected block of frequencies and is responsible for demodulating the frequencies to those within the range of the human ear, to present the title of the work.

Once a frequency is selected for encoding the title information, the title information can be encoded on this frequency and transmitted as part of the radio transmission. The radio is then responsible for separating the frequency storing the title information and storing it.

Although using a sub-band frequency as described in FIG. 4A is one way to encode the title information, it is not the only way to transmit title information. FIG. 5 shows a graph of frequencies used in radio transmission, for which a sideband transmission can be chosen on which to broadcast the title of a work according to the first embodiment of the invention. In FIG. 5, carrier frequency 505 is the frequency on which the performance is being transmitted. In FIG. 5, carrier frequency 505 is centered at 107.5 megahertz. There is an adjacent station at carrier frequency 510, centered at 107.7 megahertz. Within the United States, carrier frequencies 107.5 megahertz (505) and 107.7 megahertz (510) are assigned by the Federal Communications Commission to broadcasters, and for purposes of FIG. 5 are assumed to be as close as stations can come. (A person skilled in the art will recognize that the distance between carrier frequencies can be varied, as necessary.) The distance between carrier frequencies 505 and 510 is determined to maximize use of the radio spectrum without causing transmissions by different stations to interfere with each other.

Carrier sideband 515 is selected as a frequency centered slightly offset from carrier frequency 505. Carrier sideband 515 is also selected so as not to interfere with either carrier frequency 505 or its neighbor (not shown in FIG. 5). Carrier sideband can then be used to transmit title information. Using a carrier sideband frequency such as carrier sideband 515 allows transmission of title information in a manner that does not require modulating the title information into the performance transmission, at the price of requiring a transmitter and receiver designed to handle sideband frequencies.

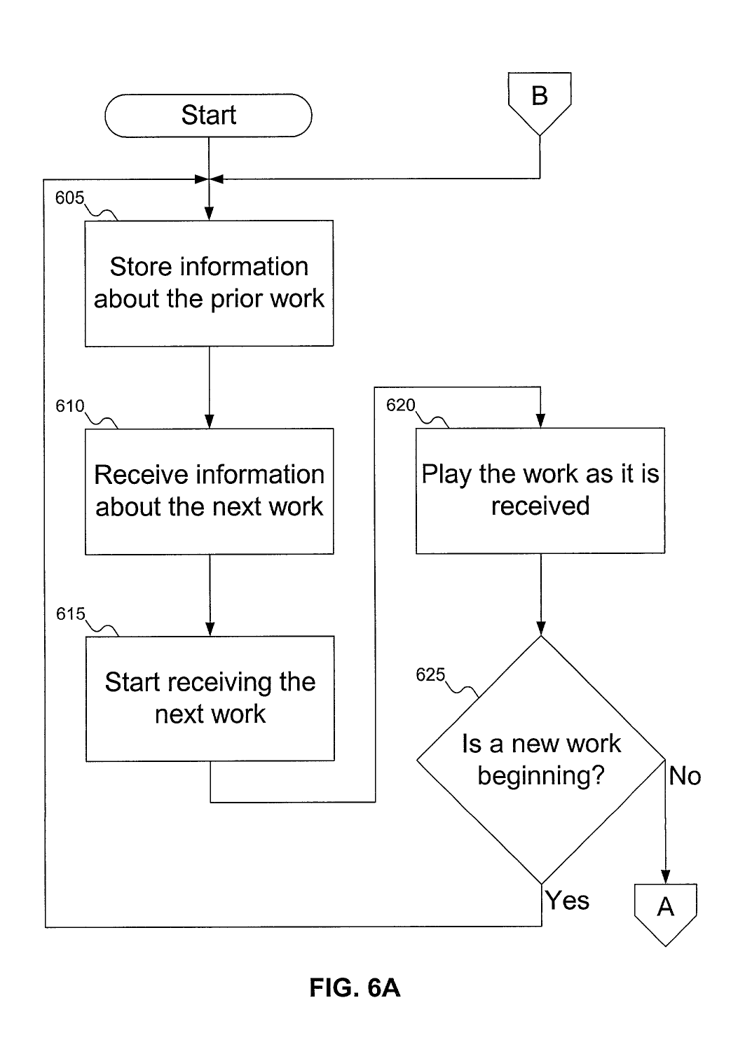

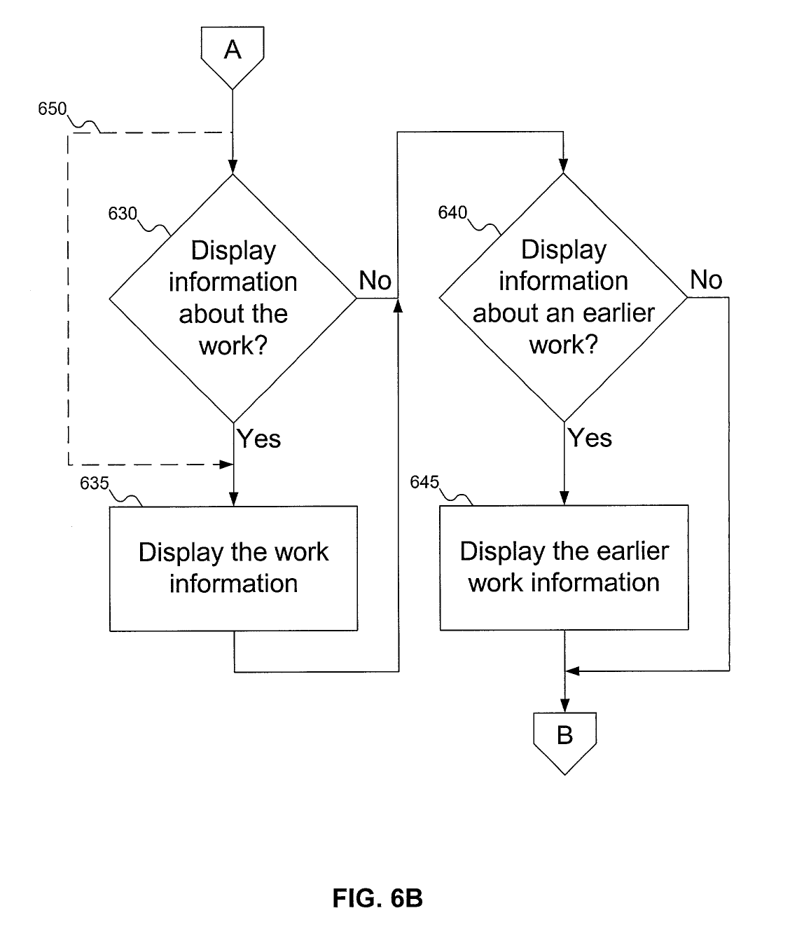

FIGS. 6A-6B show a flowchart of the method for storing and presenting to the user the title of a work being performed on the radio of FIG. 1 according to the first embodiment of the invention. In FIG. 6A, at step 605, information about the prior work is stored for access after the end of the performance. As discussed above with reference to FIG. 2, step 605 can be an optional step, not automatically performed by the receiver. At step 610, the receiver receives information about the next work. At step 615, the receiver begins to receive the work. As discussed above, the title of the work and the work itself can both be transmitted at the same time, rather than serially. At step 620, as the work is received, it is performed. At step 625, the radio checks to see if a new work is beginning, for example, by noting that the information received about the work has changed. Alternatively, an end-of-work signal can be sent, indicating that a new work is beginning. If a new work is beginning, then the method returns to step 605. Otherwise, at step 630, the radio checks to see if the user has requested the title of the work. If the user has requested the title of the work, then at step 635 the title is presented. At step 640, the radio checks to see if the user has requested presentation of a previous work. If the user has requested presentation of an earlier work, then at step 645, the title of the earlier work is presented. Then, in either case, the method returns to step 605.

Although in the first embodiment the title of the work is only presented when the user requests it, a variation of the first embodiment has the title of the work being continuously presented to the user. This is represented in FIG. 6B by line 650, which skips the check of whether the user requested presentation of the title of the work.

Discussed above, with reference to FIG. 1, is the modification of a transmitter to transmit title information along with the performance of a work. FIG. 7 shows a flowchart of the method for loading and broadcasting the title of a work on the transmitter of FIG. 1 according to an embodiment of the invention. At step 705, the title of the performance is loaded into the transmitter. As discussed above with reference to FIG. 1, the title can be loaded by entry with a keyboard, by speaking the title into a microphone, or by reading the title information off a medium storing the performance. A person skilled in the art will recognize other ways the title of the work can be loaded into the transmitter. At step 710, the performance is broadcast. Finally, at step 715, the title of the performance is broadcast. As discussed above, the title of the performance can be transmitted interleaved with the performance, on a sub-band frequency, or on a carrier sideband. Additionally, the title of the performance and the performance itself are generally transmitted in parallel rather than serially.

Aside from the ability to provide the user with information about the work being performed, an advantage of the first embodiment of the invention is that the design of the first embodiment is completely compatible with existing technology. Existing radios will be able to receive transmission of works, ignoring the title information (which existing radios are not able to decode). A radio according to the first embodiment of the invention is also compatible with existing transmissions, which do not transmit title information. This makes it possible for radios according to the first embodiment of the invention to receive performances transmitted from existing transmitters. This makes it possible to phase in the new technology without requiring a sudden shift in equipment, either on the part of transmitter or receivers.

Although a number of variations of the first embodiment of the invention are described above, a person skilled in the art will recognize that the variations do not have to be kept separate. As desired, the variations can be combined, to produce a radio providing all the desired functions.

### Portable Playback Devices

FIG. 8 shows a portable playback device presenting the title of the work to the user according to a second embodiment of the invention. In FIG. 8, playback device 805 is a portable CD player playing a CD. If the user presses title button 810, the title of the work is presented to the user via display 815. Alternatively, as discussed above, playback device 805 can temporarily override or pause its normal output and, using a synthesized voice, aurally announce the title of the work; in FIG. 8, the title is aurally presented through headphones 820. Playback device 805 uses speech generator 825 to generate the synthesized voice presenting the title of the work through headphones 820.

Just like the radio in FIG. 2, playback device 805 includes storage 210-1 for storing the title of the work being performed. Although portable playback devices do not depend on transmission and some varieties of portable playback devices can randomly access tracks on the media can access the title when needed, storing the title in the storage 210-1 when the media is first accessed allows the process to be generally applicable without requiring special implementation for each playback device.

In an alternative embodiment, playback device 805 is capable of speech recognition. Then, the user can speak into microphone 830 and aurally request the title for voice-activated command and control.

Although FIG. 8 shows a portable CD player, a person skilled in the art will recognize that the second embodiment of the invention can be generalized to many different playback devices. For example, the invention is applicable to portable audiocassette players, portable minidisc players, portable digital versatile disk (DVD) players, shelf videocassette recorders/players (VCRs), shelf CD players, and shelf minidisc players, among other devices. Each “track” on the medium can include a title. The title for the track currently being performed is accessed and stored in storage 210. (For VCR and DVD players, the title of the work can be overlaid on top of the video image being displayed on the television.) Finally, the invention is applicable to computers as well: computers playing back works on media storing recorded titles can present them to the user on the monitor, without having to access them over the Internet.

One variation of the second embodiment of the invention has the track information stored at the beginning of each track (i.e., at the start of the recording of an individual work on the medium). This variation is useful for media that are not random-access media (such as audiocassettes and videocassettes). Since the non-random-access media might not be inserted at the beginning of a track, locating the track information would require rewinding the media to the track information, then forwarding the media to the point at which the media was inserted. The delay imposed by rewinding and fast-forwarding a non-random access medium is undesirable. By including the track information at the start of each track rather than in a media header, track information would only be unavailable for the track at which the media was inserted. This variation also allows for the definition of tracks on the media, as non-random-access media typically are not divided into tracks.

In another variation of the second embodiment, storage 210-1 is a non-volatile storage. With a volatile storage, the track information is lost when playback device 805 is turned off. But often the media is not ejected until after playback device 805 is used again. By using a non-volatile storage, the track information for the track on the media at which playback device 805 is turned on is still available. In this variation of the second embodiment of the invention, storage 210-1 is not erased until the media is removed from playback device 805. This variation of the second embodiment is especially advantageous for non-random access media, given the delay in rewinding a medium to the point on the medium where the track information is stored, and then fast-forwarding through the medium to where the medium was earlier stopped.

FIG. 9 is a flowchart of the method for presenting to the user the title of a work being performed according to the second embodiment of the invention. At step 905, the titles of the tracks on the medium are buffered within the playback device. As discussed above, particularly with non-random access media, it can happen that track information for only one track is buffered at a time at step 905. At step 910, the work is performed. At step 915, the playback device receives a user request for the title of the work. Finally, at step 920, the playback device presents the title of the work to the user.

Although a number of variations of the second embodiment of the invention are described above, a person skilled in the art will recognize that the variations do not have to be kept separate. As desired, the variations can be combined, to produce a playback device providing all the desired functions.

### Recording the Title Information

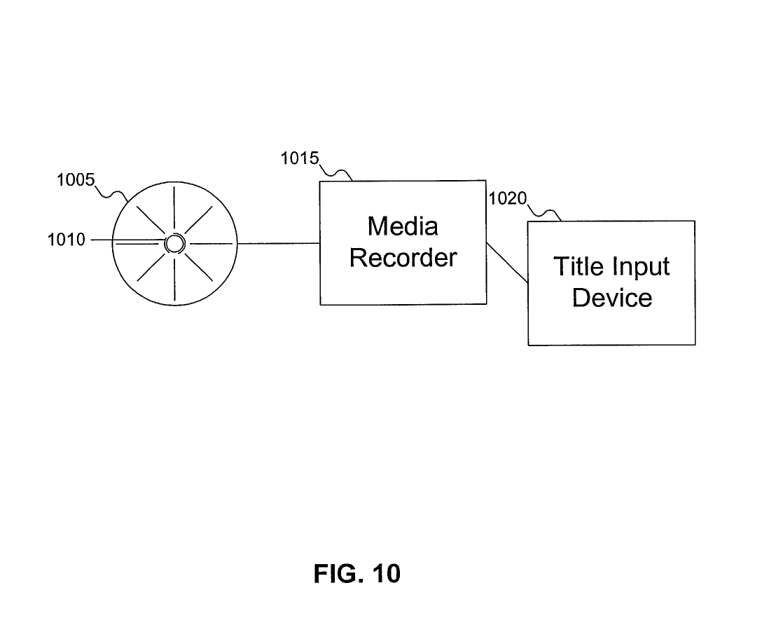

FIG. 10 shows a medium on which the title of a work can be stored according to a third embodiment of the invention. In FIG. 10, CD 1005 is shown. CD 1005 includes track 1010, on which is stored title information. In the preferred variation of the third embodiment of the invention, track 1010 is the first track of CD 1005 (i.e., track 1010 is part of the header information on the CD). But a person skilled in the art will recognize that track 1010 can be stored elsewhere on CD 1005, and that there can be multiple tracks 1010 stored throughout CD 1005 (for example, so that each track of the CD has its title information stored with the track).

Media recorder 1015 is known in the art, and is used to record the work on CD 1005. Coupled to media recorder 1015 is title input device 1020. Title input device, like transmitter 120 of FIG. 1, can include a keyboard, a microphone, or any other device for inputting title information. For example, a personal computer connected to a CD burner is a well-known type of media recorder 1015.

Although in FIG. 10 the medium is shown as a CD, a person skilled in the art will recognize that other forms of media can be used. For example, CD 1005 can be replaced with an audiocassette, a minidisc, a videocassette, a DVD, or any other recording medium.

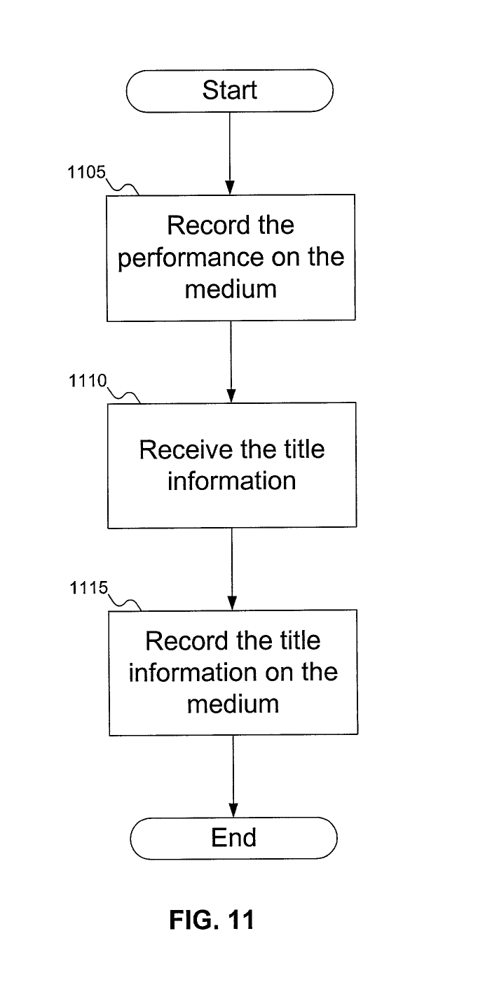

FIG. 11 shows a flowchart of the method for recording a work and the title of a work on the medium of FIG. 10 according to the third embodiment of the invention. At step 1105, the performance is recorded on the medium. At step 1110, the title information is received, and at step 1115 the title information is recorded onto the medium.

Having illustrated and described the principles of our invention in a preferred embodiment thereof, it should be readily apparent to those skilled in the art that the invention can be modified in arrangement and detail without departing from such principles. We claim all modifications coming within the spirit and scope of the accompanying claims.

We claim:

1. A broadcast receiver equipped to identify a performance on the broadcast receiver, the broadcast receiver comprising:
a passive title receiver designed to passively receive a title of the performance without actively requesting the title of the performance;
storage within the broadcast receiver for the title of the performance;
title presentation means for presenting the title to a user; and
a performance receiver designed to receive the performance.

2. A broadcast receiver according to claim 1, wherein the performance receiver and the passive title receiver are combined in a single receiver.

3. A broadcast receiver according to claim 1, further comprising title request means for the user to request the title be presented.

4. A broadcast receiver according to claim 3, wherein the title presentation means is responsive to the title request means.

5. A broadcast receiver according to claim 3, wherein the title request means includes a button on the broadcast receiver.

6. A broadcast receiver according to claim 3, wherein the title request means includes a speech recognition device responsive to the user's voice.

7. A broadcast receiver according to claim 1, wherein the title presentation means includes a display to present the title visually to the user.

8. A broadcast receiver according to claim 7, wherein the display includes a light emitting diode (LED) display.

9. A broadcast receiver according to claim 7, wherein the display is part of a heads-up display system.

10. A broadcast receiver according to claim 7, wherein the display includes a holographic display.

11. A broadcast receiver according to claim 1, wherein the title presentation means includes a speech generating device to recite the title to the user.

12. A broadcast receiver according to claim 1, the broadcast receiver further comprising title saving means for the user to request the title be saved beyond a termination of the performance.

13. A broadcast receiver according to claim 12, wherein the title saving means includes a second storage within the broadcast receiver to store the title beyond the termination of the performance.

14. A broadcast receiver according to claim 1, the broadcast receiver further comprising title selection means to toggle between a first part and second part of the title of the performance.

15. A broadcast receiver according to claim 1, wherein the passive title receiver is designed to receiver the title of the performance in a sideband of a radio-frequency signal.

16. A broadcast receiver according to claim 15, wherein the sideband transmission uses a frequency inaudible to the human ear.

17. A method for using a broadcast receiver equipped to identify a performance on the broadcast receiver, the method comprising:
performing a performance;
passively receiving a title of the performance without requesting the title of the performance;
receiving a request to present the title of the performance; and
presenting the title of the performance.

18. A method according to claim 17, wherein performing a performance includes receiving the performance on a radio-frequency signal.

19. A method according to claim 18, wherein passively receiving the title of the performance includes receiving the title of the performance as part of receiving the performance on the radio-frequency signal.

20. A method according to claim 18, wherein passively receiving the title of the performance includes passively receiving the title of the performance on a sideband of the radio-frequency signal.

21. A method according to claim 17, wherein passively receiving a title of the performance includes storing the title of the performance in memory within the broadcast receiver.

22. A method according to claim 17, wherein presenting the title of the performance includes visually presenting the title of the performance.

23. A method according to claim 22, wherein visually presenting the title of the performance includes displaying the title of the performance on a heads-up display.

24. A method according to claim 22, wherein visually presenting the title of the performance includes displaying the title of the performance using a holographic display.

25. A method according to claim 22, wherein visually presenting the title of the performance includes displaying the title of the performance on a light emitting diode (LED) display.

26. A method according to claim 17, wherein presenting the title of the performance includes aurally presenting the title of the performance.

27. A method according to claim 26, wherein aurally presenting the title of the performance includes generating speech for the title of the performance.

28. A method according to claim 26, wherein aurally presenting the title of the performance includes playing a pre-generated spoken title of the performance.

29. A method according to claim 17, wherein presenting the title of the performance includes receiving a request for the title of the performance.

30. A method according to claim 29, wherein receiving a request for the title of the performance includes receiving a button press requesting the title of the performance.

31. A method according to claim 29, wherein receiving an oral request for the title of the performance.

32. A method according to claim 31, wherein receiving an oral request for the title of the performance includes recognizing a speech in the oral request.

33. A method according to claim 17, the method further comprising storing the title of the performance beyond a termination of the performance.

34. A method according to claim 33, wherein storing the title of the performance includes receiving a request to store the title of the performance.

35. A portable music device equipped to identify a performance on the portable music device, the portable music device comprising:
storage within the portable music device for a title of the performance; and
title presentation means for presenting the title to a user.

36. A portable music device according to claim 35, the portable music device further comprising title request means for the user to request the title be presented.

37. A portable music device according to claim 36, wherein the title presentation means is responsive to the title request means.

38. A portable music device according to claim 36, wherein the title request means includes a button on the portable music device.

39. A portable music device according to claim 35, wherein the title presentation means includes a display to present the title to the user.

40. A portable music device according to claim 39, wherein the display a liquid crystal display (LCD).

41. A portable music device according to claim 35, wherein the title presentation means includes a speech generating device to recite the title to the user.

42. A portable music device according to claim 35, the portable music device further comprising title saving means for the user to request the title be saved beyond a termination of the performance.

43. A portable music device according to claim 42, wherein the title saving means includes a button on the broadcast receiver.

44. A portable music device according to claim 42, wherein the title saving means includes a second storage within the broadcast receiver to store the title beyond the termination of the performance.

45. A method for using a portable music device equipped to identify a performance on the portable music device, the method comprising:
performing the performance with a title;
receiving a request to present the title of the performance; and
presenting the title of the performance.

46. A method according to claim 45, wherein performing the performance includes receiving the title of the performance.

47. A method according to claim 46, wherein receiving the title of the performance includes accessing the title of the performance from a medium on which the performance is stored.

48. A method according to claim 46, wherein receiving the title of the performance includes storing the title of the performance in memory within the portable music device.

49. A method according to claim 45, wherein presenting the title of the performance includes visually presenting the title of the performance.

50. A method according to claim 49, wherein visually presenting the title of the performance includes displaying the title of the performance on a display connected to the broadcast receiver.

51. A method according to claim 49, wherein visually presenting the title of the performance includes displaying the title of the performance on a light emitting diode (LED) display.

52. A method according to claim 45, wherein presenting the title of the performance includes receiving a request for the title of the performance.

53. A method according to claim 52, wherein receiving a request for the title of the performance includes receiving a button press requesting the title of the performance.

54. A medium designed to contain a recording of a performance and a title of the performance, the medium drawn from a set including a compact disc, a videocassette, and an audiocassette tape.

55. A medium according to claim 54, wherein:
the medium is drawn from a set including a video cassette tape and an audiocassette tape; and
the recording of the performance includes a pause separating tracks on the medium.

56. A medium according to claim 55, wherein the pause is two seconds in length.

57. A method for using a medium recording apparatus to record a title of a performance on a medium, the medium drawn from a set including a compact disc, a videocassette, and an audiocassette tape, the method comprising:
recording the performance on the medium;
receiving the title of the performance; and
recording the title of the performance on the medium.

58. A method according to claim 57, wherein receiving the title of the performance includes receiving a spoken title of the performance via a microphone.

59. A method according to claim 57, wherein receiving the title of the performance includes receiving a typed title of the performance via a keyboard.

60. A method according to claim 57, wherein recording the title of the performance on the medium includes recording the title of the performance on a first track of the medium.

61. A radio receiver comprising:
a speaker;
a receiver-demodulator unit for producing an analog overall signal which is input to the speaker to play a performance;
a filter and an analog to digital converter for filtering and converting the analog overall signal to a digital title signal; and
a processor to receive the digital title signal for determining data about the performance.

62. The radio receiver of claim 61, further comprising a memory to store the determined data.

63. The radio receiver of claim 61, further comprising a display to display the determined data.

64. The radio receiver of claim 61, further comprising a voice synthesizer to generate a voice announcement signal from the determined data.
